(19) United States
(12) Patent Application Publication
(10) Pub. No.: US 2007/0204167 A1
(43) Pub. Date: Aug. 30, 2007

(54) Method for serving a plurality of applications by a security token

(75) Inventors: Vladimir Beker, Ariel (IL); Dany Margalit, Ramat Gan (IL); Yanki Margalit, Ramat Gan (IL)

Correspondence Address: DR. MARK FRIEDMAN LTD.;C/o Bill Polkinghorn, 9003 Florin Way, Upper Marlboro, MD, 20772, US

(73) Assignee: ALADDIN KNOWLEDGE SYSTEMS LTD.

(21) Appl. No.: 11/363,058

(22) Filed: Feb. 28, 2006

(51) Int. Cl. H04L 9/00

(52) U.S. Cl. 713/183

(57) ABSTRACT

The present invention is directed to a method for serving a plurality of application programs by a security token, the method comprising the steps of: providing to each of said applications a credential for accessing a service provided by said security token, wherein the credential of one application differs from the credential of each of the other applications; upon requesting the service by one of the application programs, authenticating the user thereof; and upon positively authenticating the user by the token, providing the service to the application. The method may further comprise the step of: upon positively authenticating a user: providing to the application a marker; caching the marker; and upon requesting the service by the application program a subsequent time on the session, retrieving the cached user identity information, and presenting the information to the token. According to a preferred embodiment of the invention, the marker remains valid for a time period.

### FIELD OF THE INVENTION

The present invention relates to the field of security tokens. More particularly, the invention relates to a method for serving a plurality of applications by a security token, while each application uses its individual credentials.

### BACKGROUND OF THE INVENTION

The term “security token” refers herein to a portable computerized device for rendering security-related operation(s).

The term “security” refers herein to preventing exploiting of data and/or a service by an unauthorized party, wherein:
the term “data” refers to any information that can be stored within a memory, including a ciphering key, a password, credentials, identification information, information associated with a user;
the term “exploiting” refers to:
   accessing the data and/or service; and/or
   modifying the data and/or the information provided by the service; and/or
   rendering the data “understandable” (e.g. deciphering the data);
the operation(s) for preventing exploiting of data and/or service include:
   ciphering and deciphering of data (including symmetric and asymmetric ciphering);
   validating the integrity of data (including digitally signing of data and verification of digital signatures);
   providing one-time access keys (e.g. a one-time-password).

For example, the eToken® family of products manufactured by Aladdin Knowledge Systems Ltd. of Tel Aviv, Israel, and SafeNet manufactured by Safenet Inc., are security tokens. A security token may be based on smartcard technology, and even have a form factor of smartcard. Some cellular telephones which perform security operations may also be considered as security tokens, especially if they employ a smartcard chip or SIM (Subscriber Identification Module) for, e.g., storing confidential information.

The term “credential” refers herein to the rights of an application to use a service provided by a security token.

The term “authentication” refers herein to a process wherein a user provides identification information to a system. The “authentication information” may be a secret the user knows (e.g., a password), something the user is (e.g., a biometric sample of the user), a combination of both, etc. Upon “positively authenticating” a user by a system (i.e. providing to the system information upon which the system may “figure out” that the user is the one he claims to be), the system provides the user service(s) he is entitled to use according to his credentials. Such services may be access to restricted data, provision of one-time information (e.g., one-time password) by the token to the user, digitally signing a document, etc.

For example, a security token provides the following services: (a) stores one or more passwords which a user may use when accessing a service such as his email box; (b) stores private and confidential information; (c) stores one or more ciphering keys which a user may use for digitally signing his documents; (d) generates a one-time-password which a user may need for accessing his bank account.

In the prior art tokens were designed to provide their services upon positively authenticating a user. Thus, once a user has been positively authenticated, his credentials to use the services provided by the security token become “unlimited”.

FIG. 1 schematically illustrates a scheme of utilizing a security token, according to the prior art. A computer system 20 hosts a plurality of application programs 31, 32 and 33. A security token 10 is plugged into the computer 20 and serves the application programs 31 to 33. In order to use the services of the security token 10, the user thereof has to be positively authenticated, i.e. to provide to the token identification information 40 (e.g. a PIN). The token verifies that the authentication information is valid, and then during the current login session of the token any application executed on the computer gets “unlimited” credentials to use the token's service.

For example, application program 31 is an email client (e.g. Outlook Express) which has the ability to digitally sign emails. The key for digitally signing an email is stored within the security token 10. Application program 32 is a VPN (Virtual Private Network) client. Whenever the VPN client initiates a communication session with the VPN, the client has to present a valid PIN (the credentials).

Using the same credentials for all the applications executed by a computer is a drawback, since in this way any application familiar with the protocol of communicating with the security token can use the services of the security token once the user has been positively authenticated by the security token.

It is an object of the present invention to provide a method for using a security token by a plurality of application programs or users simultaneously such that each application uses its own credentials.

Other objects and advantages of the invention will become apparent as the description proceeds.

### SUMMARY OF THE INVENTION

In one aspect, the present invention is directed to a method for serving a plurality of application programs by a security token, the method comprising the steps of: providing to each of said applications a credential for accessing a service provided by said security token, wherein the credential of one application differs from the credential of each of the other applications; upon requesting the service by one of the application programs, authenticating the user thereof, and upon positively authenticating the user by the token, providing the service to the application.

The method may further comprise the steps of: upon requesting the service by one of the application programs the first time on a session, authenticating the user and caching the user identity information thereof; and upon requesting the service by the application program from the second time in the session and on, retrieving the cached user identity information, and presenting the information to the token.

The method may further comprise the step of: upon positively authenticating a user; providing to the application a marker; caching the marker; and upon requesting the service by the application program a subsequent time on the session, retrieving the cached user identity information, and presenting the information to the token.

According to a preferred embodiment of the invention, the marker remains valid for a time period.

The session may be the time period from when the security token is plugged into a computer until the security token is unplugged from the computer, the time period since the application program began its execution until the application program stops its execution, the time period from when the computer is turned on until the computer is turned off, etc.

The service may comprise storing information, storing a cipher key, storing a password, storing confidential information, storing private information, generating a password, generating a one-time password, digitally signing a document, etc.

The marker may be a pseudo-random number, a pseudo-random string, a pseudo-random value, a cryptographic key, etc.

### BRIEF DESCRIPTION OF THE DRAWINGS

The present invention may be better understood in conjunction with the following figures:

FIG. 1 schematically illustrates a scheme of utilizing a security token, according to the prior art.

FIG. 2 schematically illustrates a scheme of utilizing a security token, according to a preferred embodiment of the invention.

FIG. 3 is a flowchart of a method for providing a service to an application by a security token, in a situation wherein the security token provides services to a plurality of applications, according to a preferred embodiment of the invention.

FIG. 4 is a flowchart of a method for serving an application by a security token, in a situation wherein the security token provides services to a plurality of applications, according to a further preferred embodiment of the invention.

FIG. 5 is an extension of the flowchart of FIG. 4, in which the marker has a limited “lifetime”, according to a preferred embodiment of the invention.

### DETAILED DESCRIPTION OF PREFERRED EMBODIMENTS

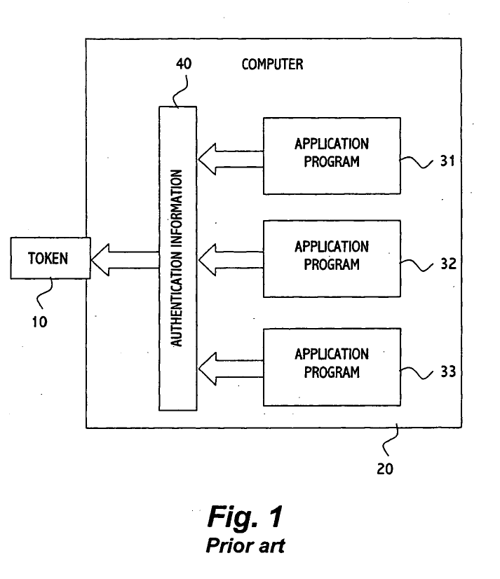

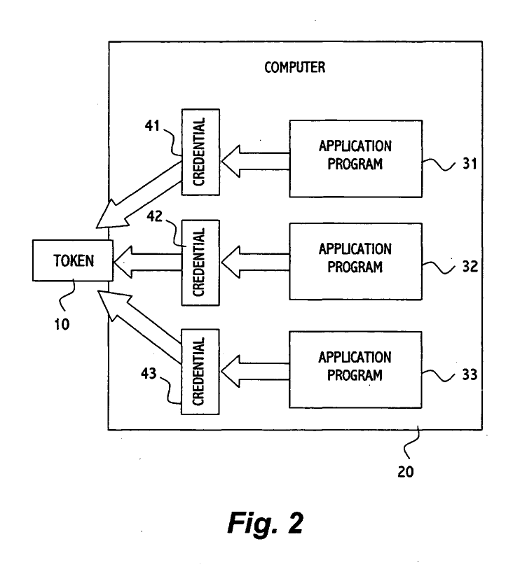

FIG. 2 schematically illustrates a scheme of utilizing a security token, according to a preferred embodiment of the invention. In contrast to the embodiment of the prior art as illustrated in FIG. 1, according to this embodiment of the invention each application program 31, 32 and 33 uses its own credential 41, 42 and 43 correspondingly.

On the one hand employing different credentials for each application program increases the overall security of a system, since one application cannot receive from the token a service dedicated to another application, but on the other hand, this requires functionality such as management of the accesses to the token, which results in additional obstacles that a system must overcome. For example, whenever one application initiates a “service session” with a token, other applications have to wait until the session ends. This requires using queuing, priorities, etc.

In order to allow an application program to use only its own credentials, according to one embodiment of the invention, on each service session with a token the application must present to the token valid authentication information and the credentials for the session. From the security point of view, this protocol can be considered as a “good” solution, but from the user point of view, it is not practical, since it involves a significant amount of inconvenience to the user.

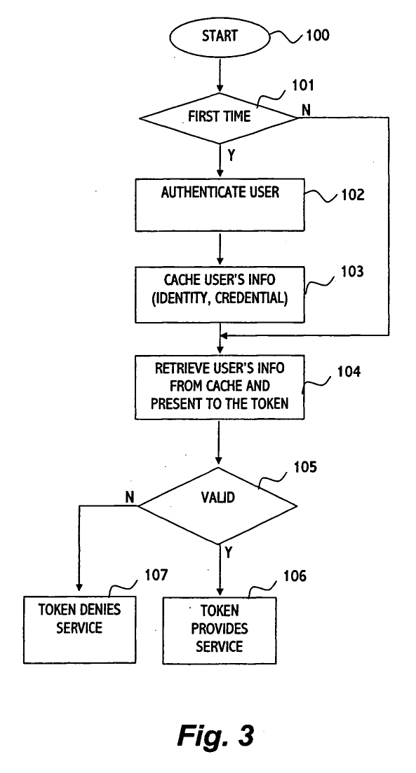

According to a preferred embodiment of the invention, instead of providing to the token the authentication information and the credentials of the application, this information is cached on the user's computer, and whenever a service session with the token is activated, the information is retrieved from the cache and sent to the token. This solution is described in FIG. 3.

FIG. 3 is a flowchart of a method for providing a service to an application by a security token, in a situation where the security token provides services to a plurality of applications, according to a preferred embodiment of the invention.

The process starts at block 100.

From block 101, if this is the first time the application uses the service during the present login session of the computer, the flow continues with block 102, wherein the user is authenticated, i.e., the user provides information upon which a system can verify that he is the one he claims to be (“user identity information); and with block 103, wherein the user's identity information is cached. Otherwise, the flow continues with block 104.

The user may be authenticated by a plurality of means known in the art, such as something he alone knows (e.g. password, PIN, and so forth), something he has (e.g., biometric sample), etc.

According to a preferred embodiment of the invention, caching the user's identity information is carried out by storing the user's identity information in a temporary volatile memory of the computer. In this way, upon logging off the computer, the credentials “expire”.

At block 104, the cached information is retrieved and presented to the token.

From block 105, if the user is positively authenticated (i.e., the token indicates that the user is who he claims to be), then on block 106 the token provides its service; otherwise on block 107 the token denies the service.

Caching is a well-known term in the computer art, and it relates to temporary storing of data for a certain purpose. For example, computer hardware makes use of cache memory, which differs from other types of memory used by a computer by the quick access.

According to one embodiment of the present invention, the purpose of the caching (see FIG. 3 block 103) is sparing the need to authenticate a user each time a security token is asked to provide a service. In this way, the user thereof has to be authenticated only once during a “session”, which results in less inconvenience to the user. A “session” may be the time period from the moment a security token is plugged into a computer until the token is plugged out of the computer, the time period a software application is executed, the time period from the moment the computer is turned on until it is turned off, and so forth.

This solution has several drawbacks and problems to be solved:
The security “shield” leaks, since the credentials are exposed to potential “hackers” as being stored within a computer's memory (RAM, disk storage, etc.).
In the prior art, it is common to authenticate a user by a biometric sample provided directly to the token, and not to the computer. In this way, the biometric data is not exposed to computer hackers. In this case, credentials caching is not applicable, as the credentials are provided directly to the security token.

A multi-application environment, i.e., wherein a plurality of applications use a single security token simultaneously, faces obstacles which a single application environment is free of, such as management, queuing, etc. According to a preferred embodiment of the invention, communication sessions with the token are “serialized”, i.e., upon initiating a service session between an application program and a security token, requests from other applications are denied until the current session ends. When a service session ends, the security token also “logs off” the open credentials, thereby preventing other applications from using these credentials. In this way, each time an application appeals for a service from a security token, the application has to again present its credentials to the security token. In other words, the application has to be authenticated by the security token multiple times.

The term “marker” refers herein to a pseudo-random number (string, value, cryptographic key, etc.) associated with credentials to use one or more services provided by a security token.

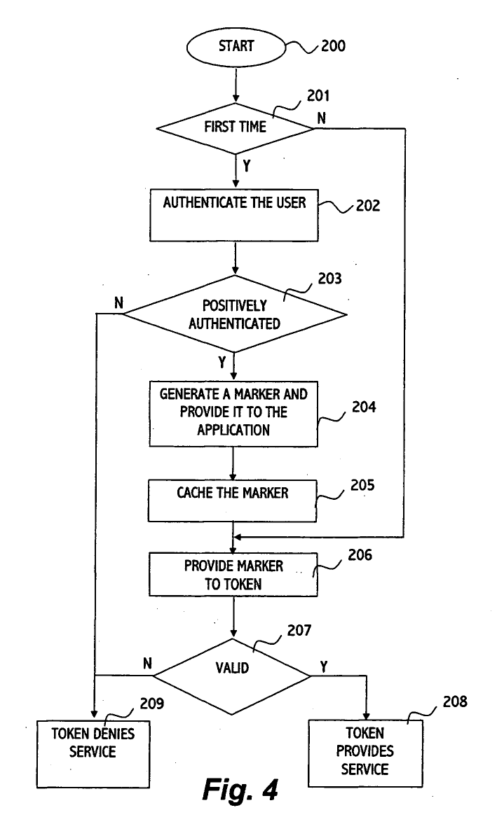

FIG. 4 is a flowchart of a method for serving an application by a security token, in a situation wherein the security token provides services to a plurality of applications, according to a further preferred embodiment of the invention.

The process starts at block 200.

From block 201, if this is the first time the service from the token has been requested by the application during the present login session of the computer (or the login session of the token or the login session of the application), then the flow continues with block 202, wherein the user is authenticated (e.g., by presenting a password); otherwise, the flow continues with block 206.

From block 203, if the user is positively authenticated, then at block 204 the token generates a marker, and provides the marker to the application; and at block 205 the marker is cached; otherwise, the flow continues with block 209, wherein the token denies the service.

At block 206, instead of presenting the user authentication information to the token, the application presents the marker to the token.

From block 207, if the marker is valid, then at block 208 the token provides the requested service to the application; otherwise, at block 209, the token denies the service.

According to one embodiment of the invention, a marker has a predefined lifetime, i.e., once the marker expires, the token generates a new marker and provides it to the application. According to this embodiment of the present invention, the markers are cached, like user identification information, which means exposure to hackers, but on the other hand, they have a restricted lifetime, which results with minimizing the security leak.

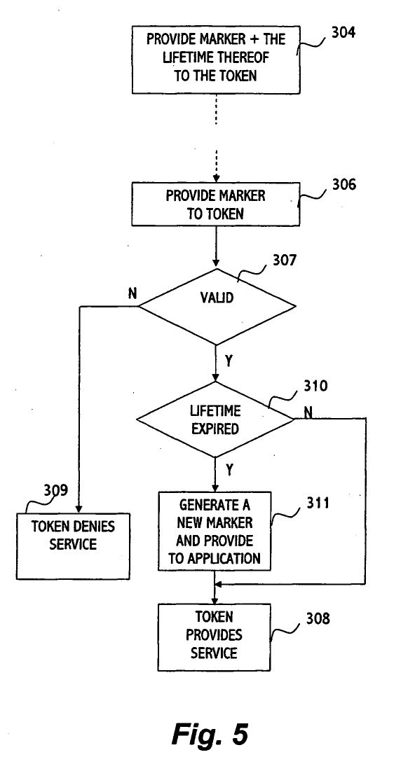

FIG. 5 is an extension of the flowchart of FIG. 4, in which the marker has a limited “lifetime”, according to a preferred embodiment of the invention.

At block 304, the token generates a marker, and provides it to the application. The marker has a limited lifetime, e.g., 5 minutes.

At block 306, the application presents the marker to the token.

From block 307, if the marker is valid, then from block 310 if the lifetime of the marker has not been expired, then from block 311 a new marker is generated by the token and provided to the application in block 308. However, if in block 307 the marker is not valid, then in block 309 the token denies the service.

Those skilled in the art will appreciate that the invention can be embodied in other forms and ways, without losing the scope of the invention. The embodiments described herein should be considered as illustrative and not restrictive.

1. A method for serving a plurality of application programs by a security token, the method comprising the steps of:
providing to each of said applications a credential for accessing a service provided by said security token, wherein the credential of any application differs from the credential of any other said application;
upon requesting said service by one of said application programs, authenticating the user thereof; and
upon positively authenticating said user by said token, providing said service to said application.

2. A method according to claim 1, further comprising the steps of:
upon requesting said service by one of said application programs a first time in a session, authenticating said user and caching the user identity information thereof; and
upon requesting said service by said application program a second or subsequent time in said session, retrieving said cached user identity information, and presenting said information to said token.

3. A method according to claim 2, further comprising the step of:
upon positively authenticating a user:
providing to said application a marker;
caching said marker; and
upon requesting said service by said application program a subsequent time in said session, retrieving the cached user identity information, and presenting said information to said token.

4. A method according to claim 2, further comprising keeping said marker valid for a time period.

5. A method according to claim 2, wherein said session is selected from the group comprising: the time period from when said security token is plugged into a computer until said security token is unplugged from said computer, the time period from when said application program starts to be executed until said application program stops its execution, the time period when said computer is turned on until said computer is turned off.

6. A method according to claim 1, wherein said service is selected from the group comprising: storing information, storing a cipher key, storing a password, storing confidential information, storing private information, generating a password, generating a one-time password, digitally signing a document.

7. A method according to claim 3, wherein said marker is selected from the group comprising: a pseudo-random number, a pseudo-random string, a pseudo-random value, a cryptographic key.
